(19) United States
(12) Patent Application Publication
(10) Pub. No.: US 2014/0352342 A1
(43) Pub. Date: Dec. 4, 2014

(54) ROOFTOP AIR CONDITIONING ASSEMBLY AND A METHOD OF CONSTRUCTING SAME

(71) Applicant: David Magro, Picton (AU)

(72) Inventor: David Magro, Picton (AU)

(73) Assignees: Daikin Industries, Ltd., Osaka (JP); Daikin Australia Pty Limited, Chipping Norton (AU)

(21) Appl. No.: 14/168,463

(22) Filed: Jan. 30, 2014

(30) Foreign Application Priority Data
May 28, 2013 (AU) 2013901898

(51) Int. Cl. F25D 23/10; B23P 15/26

(52) U.S. Cl. CPC F25D 23/10; B23P 15/26
USPC 62/259.1; 29/890.03

(57) ABSTRACT

A rooftop air conditioning assembly (60) for a building having a rooftop and an internal volume. The assembly includes a chassis (20), a plurality of outdoor sections (58), one indoor section (56) and refrigerant tubes (40). The chassis (20) is adapted for mounting adjacent one or more rooftop openings. The plurality of outdoor sections (58) are mounted on the chassis (20), with each of the outdoor sections (58) having at least one air inlet in fluid communication with atmosphere and at least one air outlet in fluid communication with atmosphere. The one indoor section (56) is mounted on the chassis (20), and has an air outlet in fluid communication with the internal volume via the one or more rooftop openings and an air inlet in fluid communication with the internal volume via the one or more rooftop openings. The refrigerant tubes (40) connect the outdoor sections (58) to the indoor section (56).

### FIELD OF THE INVENTION

The present invention relates to a rooftop air conditioning assembly for a building and a method of constructing same.

The invention has been primarily developed for use in air conditioning of large buildings such as stadiums, warehouses and shopping centres and will be described hereinafter with reference to same. However, the invention is not limited to this particular type of use and is also suitable for factories and other buildings with large areas of conditioned space adjacent to the roof

### BACKGROUND OF THE INVENTION

Rooftop air conditioning assemblies are known which comprise both an outdoor section and an indoor section. The main components of the outdoor section are a compressor(s), condenser coil(s) and a fan. The main components of the indoor section are a refrigerant metering device, heat exchanger(s) and a blower. Refrigerant tubes connect the condenser coil(s) to the cooling coil(s) via the refrigerant metering device. When cooling, the fan draws external air over the condenser coil(s) and back to atmosphere and the blower draws internal air over the evaporator coil(s) and into an internal volume of a building to be cooled. The operation is reversed for heating (i.e. reverse cycle air conditioning).

A disadvantage of existing large rooftop air conditioning assemblies is that they are typically made to order to suit a particular building and are therefore relatively expensive and have relatively long production times. Another disadvantage of known rooftop air conditioning assemblies is that their energy efficiency is dependent to an extent on the size of the condenser coil(s) and therefore an increase in energy efficiency typically requires an increase in the size of the overall assembly. A further disadvantage is that a compressor failure will stop or severely impact on the performance of the unit.

### OBJECT OF THE INVENTION

It is an object of the present invention to substantially overcome or at least ameliorate one or more of the above disadvantages.

### SUMMARY OF THE INVENTION

Accordingly, in a first aspect, the present invention provides a rooftop air conditioning assembly for a building having a rooftop and an internal volume, the assembly including:

a chassis adapted for mounting adjacent one or more rooftop openings;

a plurality of outdoor sections mounted on the chassis, each of the outdoor sections having at least one air inlet in fluid communication with atmosphere and at least one air outlet in fluid communication with atmosphere;

one indoor section mounted on the chassis, having an air outlet in fluid communication with the internal volume via the one or more rooftop openings and an air inlet in fluid communication with the internal volume via the one or more rooftop openings; and

refrigerant tubes connecting the outdoor sections to the indoor section.

The refrigerant tubes are preferably supported by the chassis. The refrigerant tubes are preferably contained within the external boundaries of the chassis.

The assembly preferably includes ductwork connecting the at least one outlet and the at least one inlet of the indoor section with the one or more rooftop openings, wherein the chassis includes gaps through which the duct work passes.

In a second aspect, the present invention provides method of constructing a rooftop air conditioning assembly for a building having a rooftop and an internal volume, the method including the steps of:

constructing a chassis adapted for mounting adjacent one or more rooftop openings;

mounting on the chassis a plurality of outdoor sections, each of the outdoor sections having at least one air inlet in fluid communication with atmosphere and at least one air outlet in fluid communication with atmosphere; and

mounting on the chassis one indoor section, having an air outlet in fluid communication with the internal volume via the one or more rooftop openings and an air inlet in fluid communication with the internal volume via the one or more rooftop openings; and

mounting refrigerant tubes to the chassis, which connect the outdoor sections and the indoor section.

The method preferably includes mounting refrigerant tubes to the chassis prior to the mounting of the outdoor sections to the chassis.

### BRIEF DESCRIPTION OF THE DRAWINGS

A preferred embodiment of the invention will now be described, by way of an example only, with reference to the accompanying drawings in which:

FIG. 1 is a perspective view of a chassis for an embodiment of a rooftop air conditioning assembly;

FIG. 2 is a perspective view of the partial assembly shown in FIG. 1 with indoor section componentry mounted thereon;

FIG. 3 is a perspective view of the partial assembly shown in FIG. 2 with further indoor section componentry mounted thereon;

FIG. 4 is a perspective view of the partial assembly shown in FIG. 3 with refrigerant tubes mounted thereon;

FIG. 5 is a perspective view of the partial assembly shown in FIG. 4 with further indoor section componentry mounted thereon;

FIG. 6 is a perspective view of the partial assembly shown in FIG. 5 with further indoor section componentry mounted thereon;

FIG. 7 is a perspective view of the partial assembly shown in FIG. 6 with further indoor section componentry mounted thereon;

FIG. 8 is a perspective view of the partial assembly shown in FIG. 7 with further indoor section componentry mounted thereon;

FIG. 9 is a perspective view of the partial assembly shown in FIG. 8 with outdoor section componentry mounted thereon; and

FIG. 10 is a perspective view of the completed embodiment of the rooftop air conditioning assembly.

### DETAIL DESCRIPTION OF THE PREFERRED EMBODIMENT

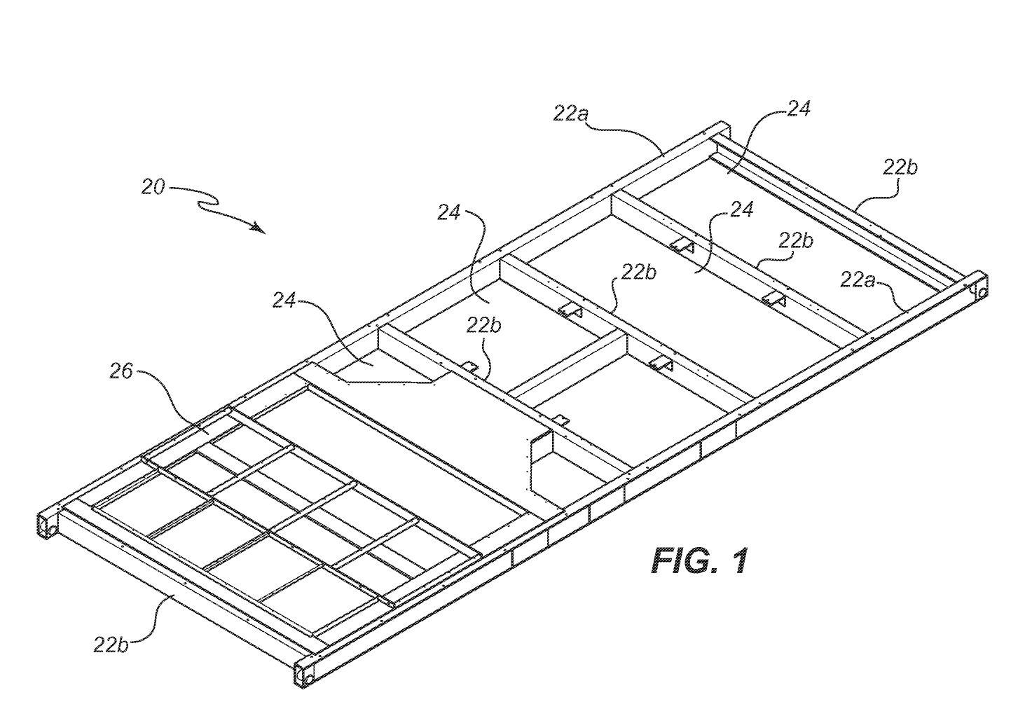

FIG. 1 shows a chassis 20 for an embodiment of a rooftop air conditioning assembly. The chassis 20 is essentially comprised of two steel C-section side members 22a and a number of steel C-section cross members 22b. A number of openings 24 are left between the side members 22a and the cross members 22b. FIG. 1 also shows a thermal insulation pad 26 fitted to the chassis 20.

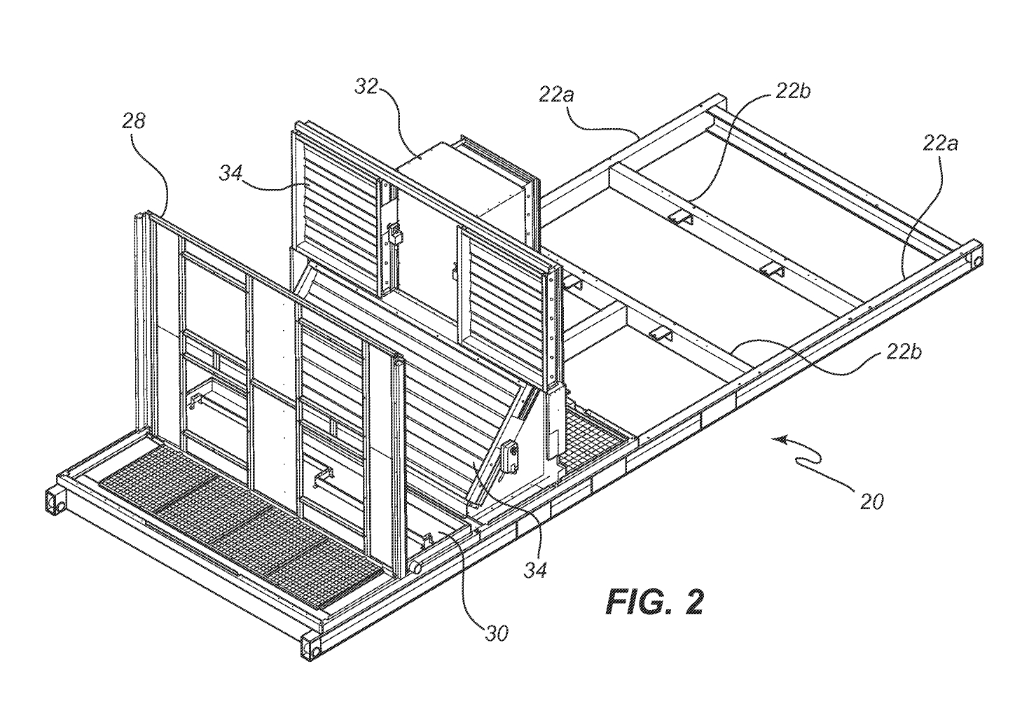

FIG. 2 shows the chassis of FIG. 1 after fitting of a fan frame 28, a drain pan 30, a smoke spill fan assembly 32 and return air duct work 34. The duct work 34 passes through the openings 24 for connection to one or more rooftop openings for communication of air between the internal volume of the building to be cooled/heated.

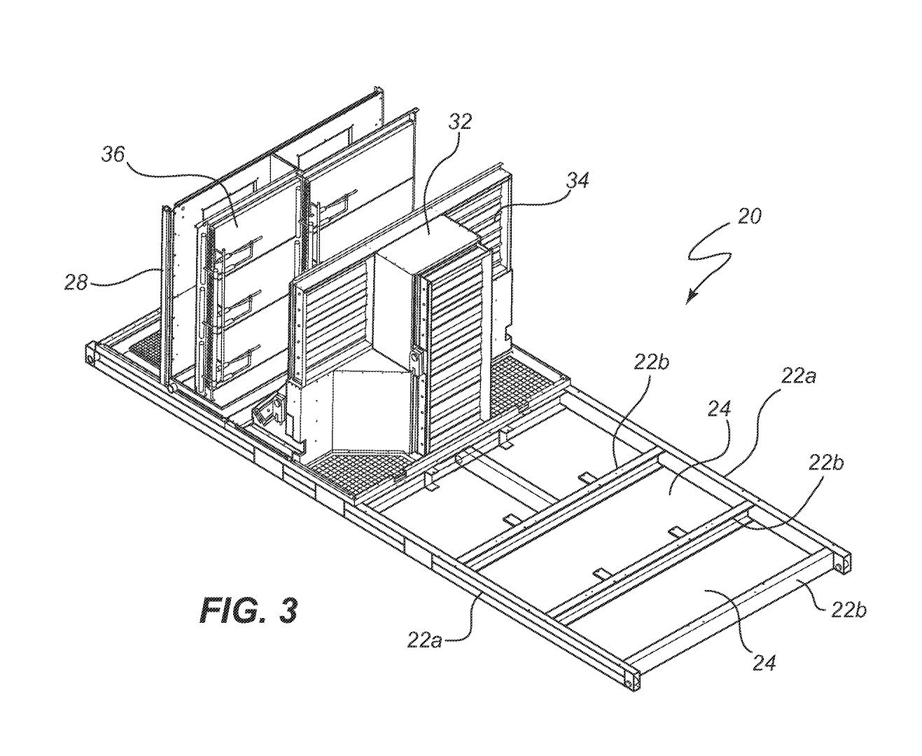

FIG. 3 shows the partial assembly of FIG. 2 after fitting of heat exchangers 36.

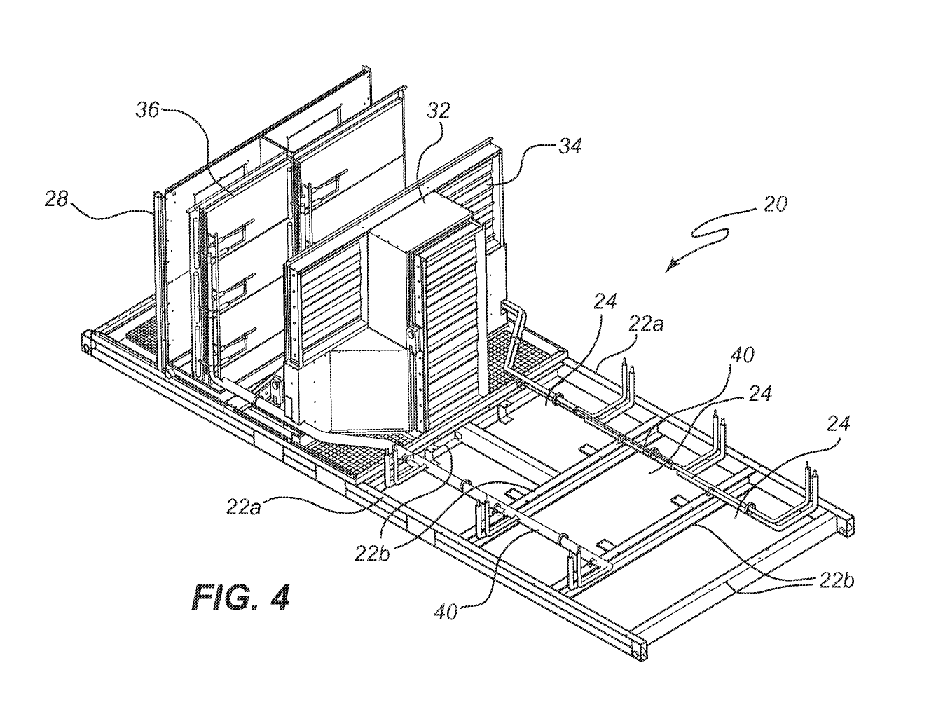

FIG. 4 shows the partial assembly of FIG. 3 after fitting of refrigeration tubes 40. The tubes 40 are securely mounted to the chassis 20 and are also contained within the external boundaries of the chassis 20. The tubes 40 are connected at one end to the heat exchangers 38.

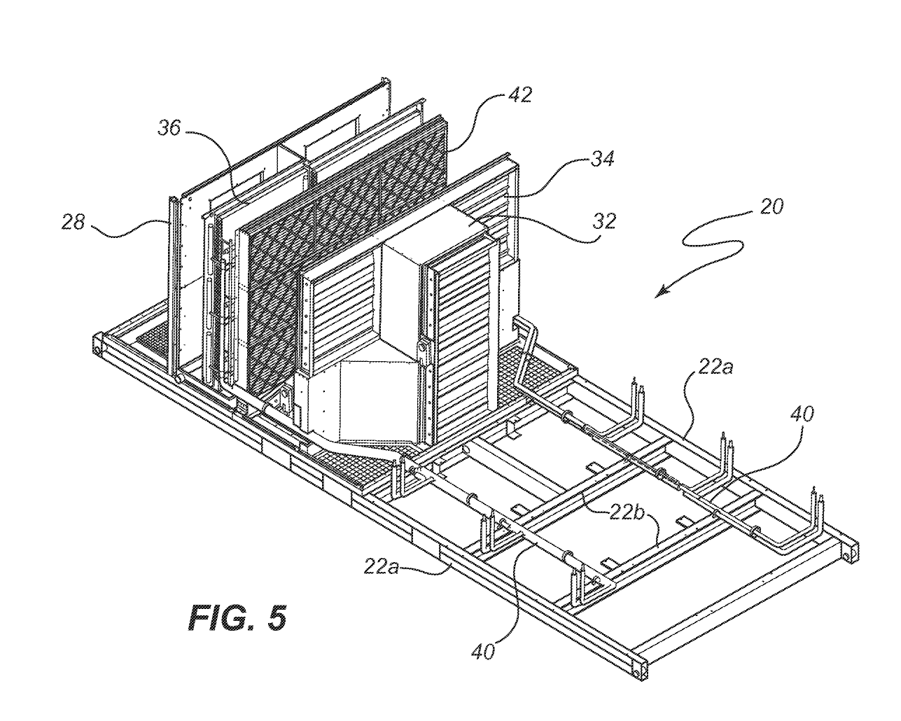

FIG. 5 shows the partial assembly of FIG. 4 after fitting of a filter assembly 42.

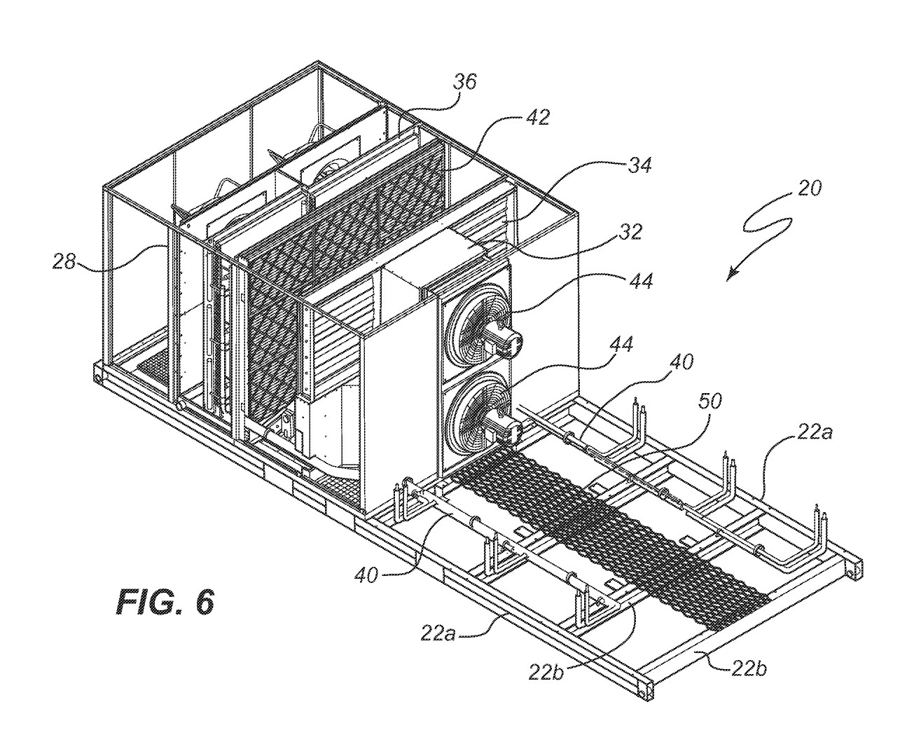

FIG. 6 shows the partial assembly of FIG. 5 after fitting of two smoke fans 44.

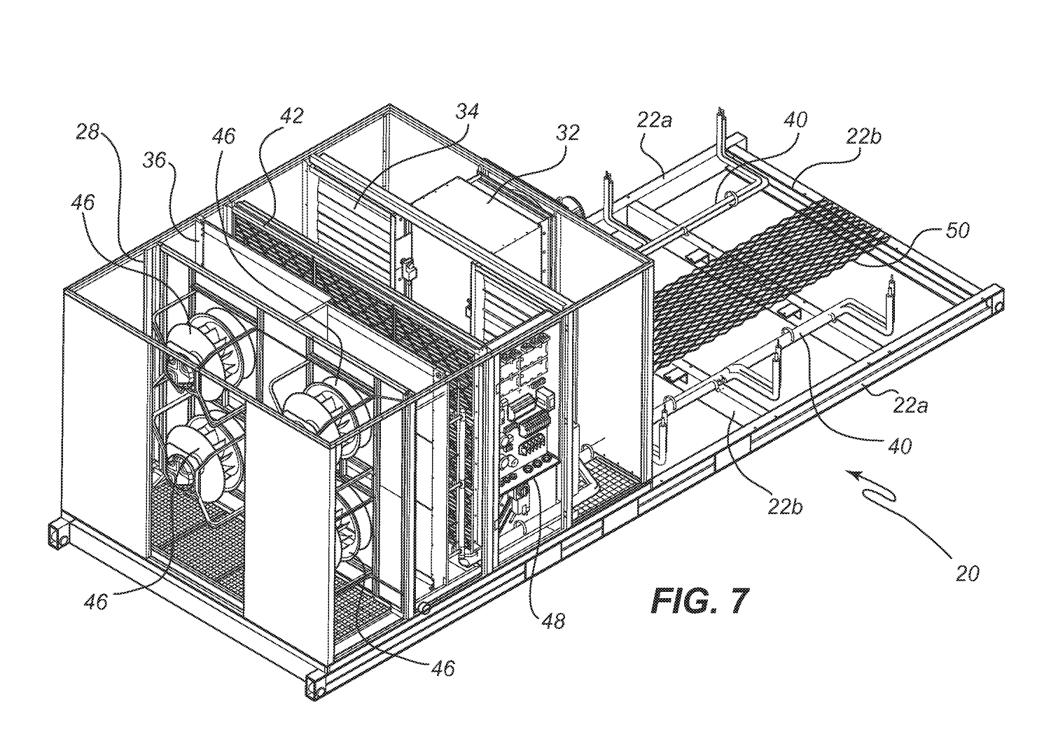

FIG. 7 shows the partial assembly of FIG. 6 after fitting of four blowers 46 and associated power and control components 48. FIG. 7 also shows a support grate 50 fitted to the chassis 20.

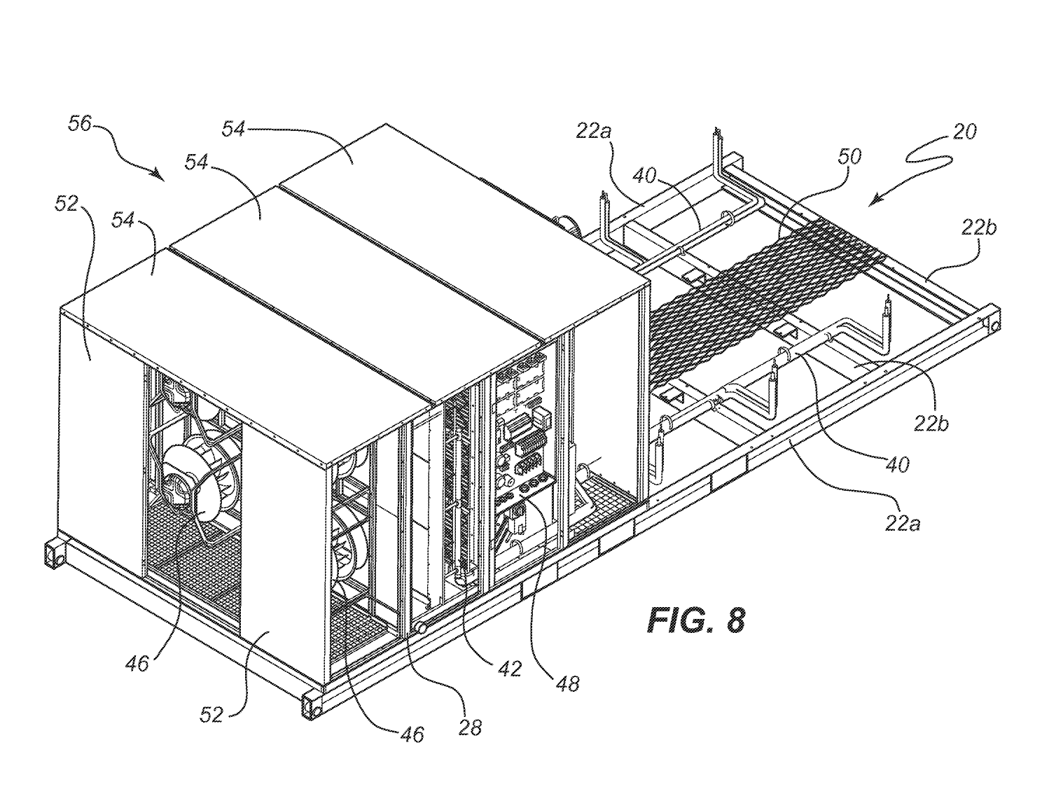

FIG. 8 shows the partial assembly FIG. 7 after fitting of panel sides 52 and panel tops 54, which complete an indoor section 56.

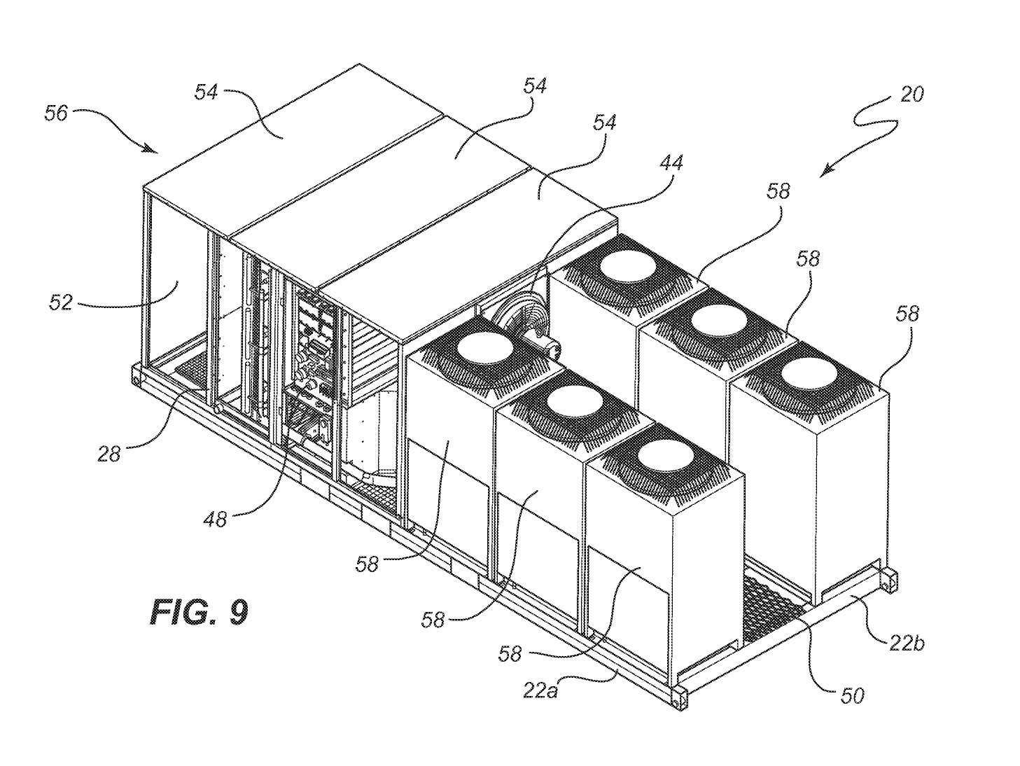

FIG. 9 shows the partial assembly of FIG. 8 after fitting of six “off-the-shelf” outdoor sections 58, which are connected to the other ends of the refrigerant tubes 40.

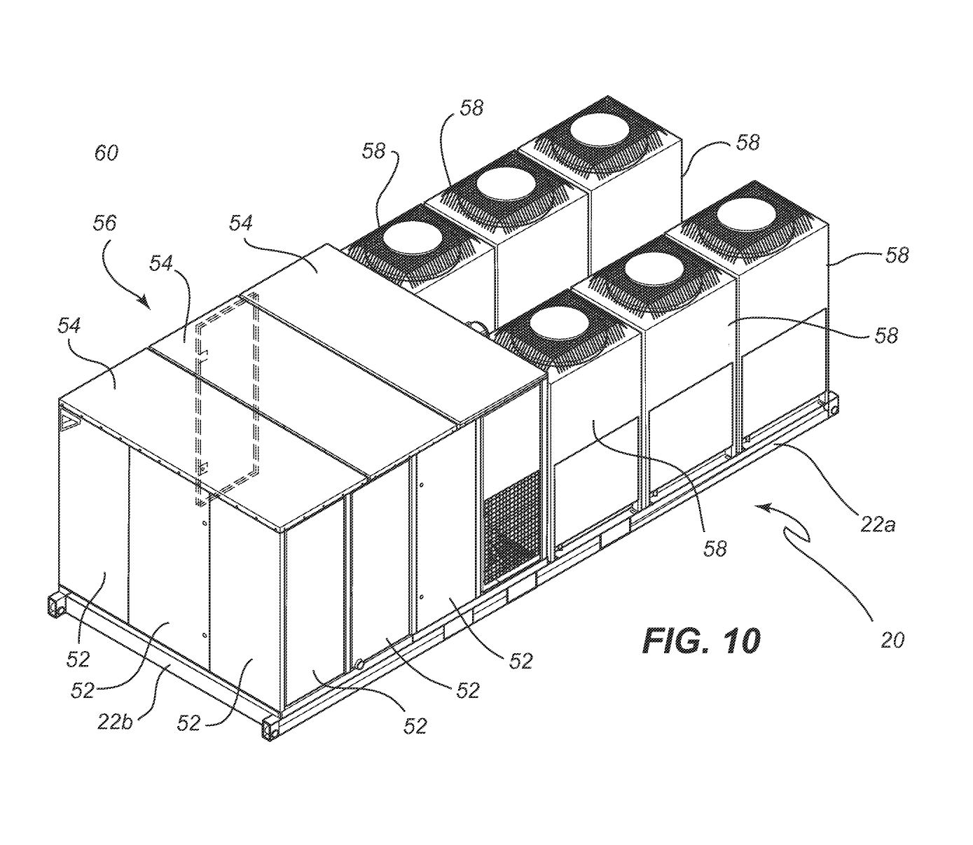

FIG. 10 shows the completed rooftop air conditioning assembly 60.

The rooftop air conditioning assembly 60 has several advantages. Firstly, the assembly 60 can be safely and securely transported from a manufacturing facility to an installation site, as the chassis 20 provides a sturdy base for transport, lifting and mounting to a building rooftop. The chassis 20 also provides protection for the refrigerant tubes 40. The chassis 20 also has provision for the mounting of a plurality of outdoor sections 58, which allows the capacity of the air conditioning assembly 60 to be quickly, efficiently and relatively inexpensively tailored it to suit buildings of various sizes and layouts, as the outdoor sections 58 are readily available off the-shelf components.

Each of the outdoor sections also have a “wrap around” 3 sided heat exchanger, which advantageously provides additional heat exchanger surface area for the same overall assembly foot print compared to known single outdoor section units.

Known roof top air conditioners typically utilise a single large compressor. Where the total capacity requires more than one compressor it is common for multiple (typically 2) refrigeration circuits to be used with each circuit having a separate or interlaced outdoor and indoor heat exchanger, metering device and compressor. Where only a single large compressor is utilised, failure of the compressor will stop the air conditioner functioning. With multiple circuits, a compressor failure will disable the complete circuit and the associated indoor heat exchanger. The “non functioning” heat exchanger is still in the conditioned air path so it will allow air to pass through it without being cooled (or heated) which will severely impact on the performance. However, with the present invention, the outdoor sections multiple compressors are effectively circuited together so a compressor failure will not disable an indoor heat exchanger (albeit the total refrigeration capacity will be reduced). In the case of a compressor failure, the complete air conditioning system will thus advantageously continue to operate and a fault signal will be transmitted to initiate repair of the faulty compressor.

Although the invention has been described with reference to a preferred embodiment, it will be appreciated by persons skilled in the art of the invention may be embodied in many other forms.

1. A rooftop air conditioning assembly for a building having a rooftop and an internal volume, the assembly including:
a chassis adapted for mounting adjacent one or more rooftop openings;
a plurality of outdoor sections mounted on the chassis, each of the outdoor sections having at least one air inlet in fluid communication with atmosphere and at least one air outlet in fluid communication with atmosphere;
one indoor section mounted on the chassis, having an air outlet in fluid communication with the internal volume via the one or more rooftop openings and an air inlet in fluid communication with the internal volume via the one or more rooftop openings; and
refrigerant tubes connecting the outdoor sections to the indoor section.

2. The rooftop air conditioning assembly as claimed in claim 1, wherein the refrigerant tubes are supported by the chassis.

3. The rooftop air conditioning assembly as claimed in claim 1, wherein the refrigerant tubes are contained within the external boundaries of the chassis.

4. The rooftop air conditioning assembly as claimed in claim 1, wherein the assembly includes ductwork connecting the at least one outlet and the at least one inlet of the indoor section with the one or more rooftop openings, wherein the chassis includes gaps through which the duct work passes.

5. A method of constructing a rooftop air conditioning assembly for a building having a rooftop and an internal volume, the method including the steps of:
constructing a chassis adapted for mounting adjacent one or more rooftop openings;
mounting on the chassis a plurality of outdoor sections, each of the outdoor sections having at least one air inlet in fluid communication with atmosphere and at least one air outlet in fluid communication with atmosphere; and
mounting on the chassis one indoor section, having an air outlet in fluid communication with the internal volume via the one or more rooftop openings and an air inlet in fluid communication with the internal volume via the one or more rooftop openings; and
mounting refrigerant tubes to the chassis, which connect the outdoor sections and the indoor section.

6. The method of constructing a rooftop air conditioning assembly as claimed in claim 5, wherein the method includes mounting refrigerant tubes to the chassis prior to the mounting of the outdoor sections to the chassis.
